(19) United States
(12) Patent Application Publication
(10) Pub. No.: US 2026/0219091 A1
(43) Pub. Date: Jul. 30, 2026

(54) APPARATUS FOR OPTICAL LIQUID SENSING IN REFILLABLE ARTICLES FOR AEROSOL PROVISION SYSTEMS

(71) Applicant: Nicoventures Trading Limited, London (GB)

(72) Inventor: Howard ROTHWELL, London (GB)

(21) Appl. No.: 19/147,149

(22) PCT Filed: Jan. 9, 2024
(86) PCT No.: PCT/GB2024/050032

§ 371 Date: Jul. 10, 2025

(30) Foreign Application Priority Data
Jan. 13, 2023 (GB) 2300556.4

(51) Int. Cl. G01F 23/292; A24F 15/015

(52) U.S. Cl. CPC G01F 23/2928; A24F 15/015

(57) ABSTRACT

A refilling device for filling an article from a reservoir, comprises: an article interface for receiving an article of an aerosol provision system, the article having a storage area for fluid and an orifice to vent air from the interior of the storage area to the exterior of the article; an energy source operable to emit energy waves, and configured to direct energy waves through the orifice and into the interior of the storage area of an article received in the article interface; a detector operable to detect energy waves returned through the orifice from the interior of the storage area and generate a corresponding output; and a controller configured to determine information about an amount of fluid in the storage area using the output of the detector.

### CROSS-REFERENCE TO RELATED APPLICATIONS

This present application is a National Phase entry of PCT Application No. PCT/GB2024/050032, filed 9 Jan. 2024, which claims priority from Great Britain Application No. 2300556.4, filed 13 Jan. 2023, each of which are fully incorporated herein by reference in their entireties.

### TECHNICAL FIELD

The present disclosure relates to apparatus and methods for liquid sensing in refillable articles for electronic aerosol provision systems, the liquid sensing being carried out via the use of energy waves, such as light waves.

### BACKGROUND

Electronic aerosol provision systems, which are often configured as so-called electronic cigarettes, can have a unitary format with all elements of the system in a common housing, or a multi-component format in which elements are distributed between two or more housings which can be coupled together to form the system. A common example of the latter format is a two-component system comprising a device and an article. The device typically contains an electrical power source for the system, such as a battery, and control electronics for operating elements in order to generate aerosol. The article, also referred to by terms including cartridge, cartomiser, consumable and clearomiser, typically contains a storage volume or area for holding a supply of aerosolisable material from which the aerosol is generated, plus an aerosol generator such as a heater operable to vaporise the aerosolisable material. A similar three-component system may include a separate mouthpiece that attaches to the article. In many designs, the article is designed to be disposable, in that it is intended to be detached from the device and thrown away when the aerosolisable material has been consumed. The user obtains a new article which has been prefilled with aerosolisable material by a manufacturer and attaches it to the device for use. The device, in contrast, is intended to be used with multiple consecutive articles, with a capability to recharge the battery to allow prolonged operation.

While disposable articles, which may be called consumables, are convenient for the user, they may be considered wasteful of natural resources and hence detrimental to the environment. An alternative design of article is therefore known, which is configured to be refilled with aerosolisable material by the user. This reduces waste, and can reduce the cost of electronic cigarette usage for the user. The aerosolisable material may be provided in a bottle, for example, from which the user squeezes or drips a quantity of material into the article via a refilling orifice on the article. However, the act of refilling can be awkward and inconvenient, since the items are small and the volume of material involved is typically low. Alignment of the juncture between bottle and article can be difficult, with inaccuracies leading to spillage of the material. This is not only wasteful, but may also be dangerous. Aerosolisable material frequently contains liquid nicotine, which can be poisonous if it makes contact with the skin.

Therefore, refilling units or devices have been proposed, which are configured to receive a bottle or other reservoir of aerosolisable material plus a refillable cartridge, and to automate the transfer of the material from the former to the latter. Alternative, improved or enhanced features and designs for such refilling devices are therefore of interest.

### SUMMARY

According to a first aspect of some embodiments described herein, there is provided a refilling device for filling an article from a reservoir, comprising: an article interface for receiving an article of an aerosol provision system, the article having a storage area for fluid and an orifice to vent air from the interior of the storage area to the exterior of the article; an energy source operable to emit energy waves, and configured to direct energy waves through the orifice and into the interior of the storage area of an article received in the article interface; a detector operable to detect energy waves returned through the orifice from the interior of the storage area and generate a corresponding output; and a controller configured to determine information about an amount of fluid in the storage area using the output of the detector.

According to a second aspect of some embodiments described herein, there is provided a method of sensing fluid in a storage area of an article, the method comprising: holding an article of an aerosol provision system in an article interface of a refilling device, the article having a storage area for fluid and an orifice to vent air from the interior of the storage area to the exterior of the article; directing energy waves through the orifice and into the interior of the storage area; detecting energy waves returned from the interior of the storage area; and determining information about an amount of fluid in the storage area using the detected energy waves.

These and further aspects of the certain embodiments are set out in the appended independent and dependent claims. It will be appreciated that features of the dependent claims may be combined with each other and features of the independent claims in combinations other than those explicitly set out in the claims. Furthermore, the approach described herein is not restricted to specific embodiments such as set out below, but includes and contemplates any appropriate combinations of features presented herein. For example, apparatus and methods for liquid sensing in refillable articles for electronic aerosol provision systems may be provided in accordance with approaches described herein which includes any one or more of the various features described below as appropriate.

### BRIEF DESCRIPTION OF THE DRAWINGS

Various embodiments of the invention will now be described in detail by way of example only with reference to the following drawings in which:

FIG. 1 shows a simplified schematic cross-section through an example electronic aerosol provision system in which embodiments of the present disclosure can be implemented;

FIG. 2 shows a simplified schematic representation of a refilling device to which embodiments of the present disclosure area applicable;

FIG. 3 shows a simplified schematic side view of a first example article of an aerosol provision system with an orifice for venting to which aspects of the disclosure are applicable;

FIG. 4 shows a simplified schematic side view of a second example article of an aerosol provision system with an orifice for venting to which aspects of the disclosure are applicable;

FIG. 5 shows a simplified schematic side view of a third example article of an aerosol provision system with an orifice for venting to which aspects of the disclosure are applicable;

FIG. 6 shows a simplified schematic side view of a fourth example article of an aerosol provision system with an orifice for venting to which aspects of the disclosure are applicable;

FIG. 7 shows a simplified schematic representation of part of an example refilling device according to an embodiment of the disclosure;

FIG. 8 shows a simplified schematic representation of part of a first example refilling device with a light-based fluid sensing system according to an embodiment of the disclosure;

FIG. 9 shows a simplified schematic representation of part of a second example refilling device with a light-based fluid sensing system according to an embodiment of the disclosure;

FIGS. 10A and 10B show views of a simplified schematic representation of part of a third example refilling device with a light-based fluid sensing system according to an embodiment of the disclosure;

FIG. 11 shows a simplified schematic representation of part of a first example refilling device with an ultrasound-based fluid sensing system according to an embodiment of the disclosure;

FIG. 12 shows a simplified schematic representation of part of a second example refilling device with an ultrasound-based fluid sensing system according to an embodiment of the disclosure;

FIG. 13 shows a flow chart of steps in an example method for determining an amount of fluid in the storage area of an article according to an embodiment of the present disclosure; and

FIG. 14 shows a flow chart of steps in an example method for implementing refilling of an article according an embodiment of the present disclosure.

### DETAILED DESCRIPTION

Aspects and features of certain examples and embodiments are discussed/described herein. Some aspects and features of certain examples and embodiments may be implemented conventionally and these are not discussed/described in detail in the interests of brevity. It will thus be appreciated that aspects and features of apparatus and methods discussed herein which are not described in detail may be implemented in accordance with any conventional techniques for implementing such aspects and features.

As described above, the present disclosure relates to (but is not limited to) electronic aerosol or vapour provision systems, such as e-cigarettes. Throughout the following description the terms “e-cigarette” and “electronic cigarette” may sometimes be used; however, it will be appreciated these terms may be used interchangeably with aerosol (vapour) provision system or device. The systems are intended to generate an inhalable aerosol by vaporisation of a substrate (aerosol-generating material) in the form of a liquid or gel which may or may not contain nicotine. Additionally, hybrid systems may comprise a liquid or gel substrate plus a solid substrate which is also heated. The solid substrate may be for example tobacco or other non-tobacco products, which may or may not contain nicotine. The terms “aerosol-generating material” and “aerosolisable material” as used herein are intended to refer to materials which can form an aerosol, either through the application of heat or some other means. The term “aerosol” may be used interchangeably with “vapour”.

As used herein, the terms “system” and “delivery system” are intended to encompass systems that deliver a substance to a user, and include non-combustible aerosol provision systems that release compounds from an aerosolisable material without combusting the aerosolisable material, such as electronic cigarettes, tobacco heating products, and hybrid systems to generate aerosol using a combination of aerosolisable materials, and articles comprising aerosolisable material and configured to be used within one of these non-combustible aerosol provision systems. According to the present disclosure, a “non-combustible” aerosol provision system is one where a constituent aerosol generating material of the aerosol provision system (or component thereof) is not combusted or burned in order to facilitate delivery to a user. In some embodiments, the delivery system is a non-combustible aerosol provision system, such as a powered non-combustible aerosol provision system. In some embodiments, the non-combustible aerosol provision system is an electronic cigarette, also known as a vaping device or electronic nicotine delivery (END) system, although it is noted that the presence of nicotine in the aerosol generating material is not a requirement. In some embodiments, the non-combustible aerosol provision system is a hybrid system to generate aerosol using a combination of aerosolisable materials, one or a plurality of which may be heated. Each of the aerosolisable materials may be, for example, in the form of a solid, liquid or gel and may or may not contain nicotine. In some embodiments, the hybrid system comprises a liquid or gel aerosol generating material and a solid aerosol generating material. The solid aerosol generating material may comprise, for example, tobacco or a non-tobacco product.

Typically, the non-combustible aerosol provision system may comprise a non-combustible aerosol provision device and an article (consumable) for use with the non-combustible aerosol provision device. However, it is envisaged that articles which themselves comprise a means for powering an aerosol generator or aerosol generating component may themselves form the non-combustible aerosol provision system. In some embodiments, the non-combustible aerosol provision device may comprise a power source and a controller. The power source may, for example, be an electric power source. In some embodiments, the article for use with the non-combustible aerosol provision device may comprise an aerosol generating material, an aerosol generating component (aerosol generator), an aerosol generating area, a mouthpiece, and/or an area for receiving and holding aerosol generating material.

In some systems the aerosol generating component or aerosol generator comprises a heater capable of interacting with the aerosolisable material so as to release one or more volatiles from the aerosolisable material to form an aerosol. However, the disclosure is not limited in this regard, and applies also to systems that use other approaches to form aerosol, such as a vibrating mesh.

In some embodiments, the article for use with the non-combustible aerosol provision device may comprise aerosolisable material or an area for receiving aerosolisable material. In some embodiments, the article for use with the non-combustible aerosol provision device may comprise a mouthpiece. The area for receiving aerosolisable material may be a storage area for storing aerosolisable material. For example, the storage area may be a reservoir. In some embodiments, the area for receiving aerosolisable material may be separate from, or combined with, an aerosol generating area.

As used herein, the term “component” may be used to refer to a part, section, unit, module, assembly or similar of an electronic cigarette or similar device that incorporates several smaller parts or elements, possibly within an exterior housing or wall. An aerosol provision system such as an electronic cigarette may be formed or built from one or more such components, such as an article and a device, and the components may be removably or separably connectable to one another, or may be permanently joined together during manufacture to define the whole system. The present disclosure is applicable to (but not limited to) systems comprising two components separably connectable to one another and configured, for example, as an article in the form of an aerosolisable material carrying component holding liquid or another aerosolisable material (alternatively referred to as a cartridge, cartomiser, pod or consumable), and a device having a battery or other power source for providing electrical power to operate an aerosol generating component or aerosol generator for creating vapour/aerosol from the aerosolisable material. A component may include more or fewer parts than those included in the examples.

The present disclosure relates to aerosol provision systems and components thereof that utilise aerosolisable material in the form of a liquid or a gel which is held in a storage area such as a reservoir, tank, container or other receptacle comprised in the system, or absorbed onto a carrier substrate. An arrangement for delivering the material from the reservoir for the purpose of providing it to an aerosol generator for vapour/aerosol generation is included. The terms “liquid”, “gel”, “fluid”, “source liquid”, “source gel”, “source fluid” and the like may be used interchangeably with terms such as “aerosol-generating material”, “aerosolisable substrate material” and “substrate material” to refer to material that has a form capable of being stored and delivered in accordance with examples of the present disclosure.

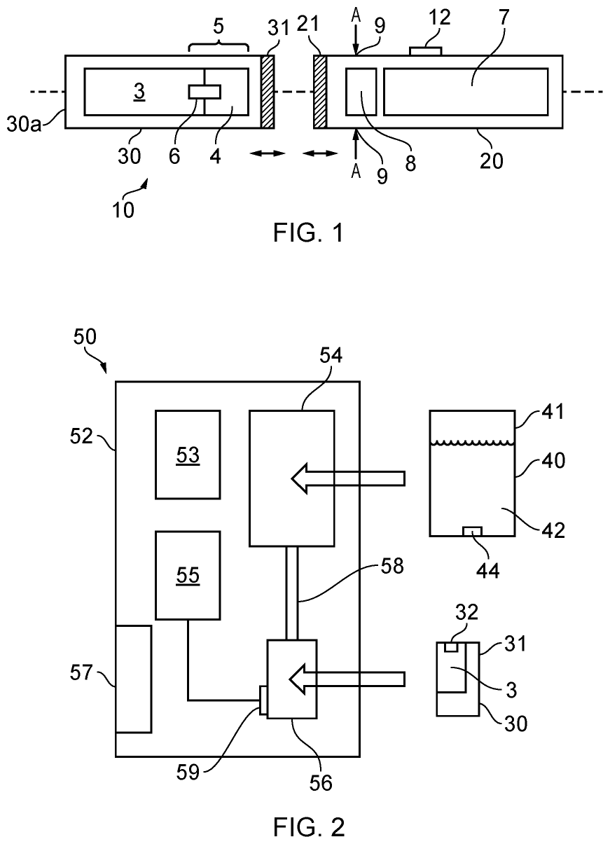

FIG. 1 is a highly schematic diagram (not to scale) of a generic example electronic aerosol/vapour provision system such as an e-cigarette 10, presented for the purpose of showing the relationship between the various parts of a typical system and explaining the general principles of operation. Note that the present disclosure is not limited to a system configured in this way, and features may be modified in accordance with the various alternatives and definitions described above and/or apparent to the skilled person. The e-cigarette 10 has a generally elongate shape in this example, extending along a longitudinal axis indicated by a dashed line, and comprises two main components, namely a device 20 (control or power component, section or unit), and an article or consumable 30 (cartridge assembly or section, sometimes referred to as a cartomiser, clearomiser or pod) carrying aerosol-generating material and operating to generate vapour/aerosol.

The article 30 includes a storage area such as a reservoir 3 for containing a source liquid or other aerosol-generating material comprising a formulation such as liquid or gel from which an aerosol is to be generated, for example containing nicotine. As an example, the source liquid may comprise around 1% to 3% nicotine and 50% glycerol, with the remainder comprising roughly equal measures of water and propylene glycol, and possibly also comprising other components, such as flavourings. Nicotine-free source liquid may also be used, such as to deliver flavouring. A solid substrate (not illustrated), such as a portion of tobacco or other flavour element through which vapour generated from the liquid is passed, may also be included. The reservoir 3 may have the form of a storage tank, being a container or receptacle in which source liquid can be stored such that the liquid is free to move and flow within the confines of the tank. In other examples, the storage area may comprise absorbent material (either inside a tank or similar, or positioned within the outer housing of the article) that holds the aerosol generating material. For a consumable article, the reservoir 3 may be sealed after filling during manufacture so as to be disposable after the source liquid is consumed. However, the present disclosure is relevant to refillable articles that have an inlet port, orifice or other opening (not shown in FIG. 1) through which new source liquid can be added to enable reuse of the article 30. The article 30 also comprises an aerosol generator 5, comprising in this example an aerosol generating component, which may have the form of an electrically powered heating element or heater 4 and an aerosol-generating material transfer component 6. The heater 4 is located externally of the reservoir 3 and is operable to generate the aerosol by vaporisation of the source liquid by heating. The aerosol-generating material transfer component 6 is a transfer or delivery arrangement configured to deliver aerosol-generating material from the reservoir 3 to the heater 4. In some examples, it may have the form of a wick or other porous element. A wick 6 may have one or more parts located inside the reservoir 3, or otherwise be in fluid communication with liquid in the reservoir 3, so as to be able to absorb source liquid and transfer it by wicking or capillary action to other parts of the wick 6 that are adjacent or in contact with the heater 4. This liquid is thereby heated and vaporised, and replacement liquid drawn, via continuous capillary action, from the reservoir 3 for transfer to the heater 4 by the wick 6. The wick may be thought of as a conduit between the reservoir 3 and the heater 4 that delivers or transfers liquid from the reservoir to the heater. In some designs, the heater 4 and the aerosol-generating material transfer component 6 are unitary or monolithic, and formed from a same material that is able to be used for both liquid transfer and heating, such as a material which is both porous and conductive. In still other cases, the aerosol-generating material transfer component may operate other than by capillary action, such as by comprising an arrangement of one or more valves by which liquid may exit the reservoir 3 and be passed onto the heater 4.

A heater and wick (or similar) combination, referred to herein as an aerosol generator 5, may sometimes be termed an atomiser or atomiser assembly, and the reservoir with its source liquid plus the atomiser may be collectively referred to as an aerosol source. Various designs are possible, in which the parts may be differently arranged compared with the highly schematic representation of FIG. 1. For example, and as mentioned above, the wick 6 may be an entirely separate element from the heater 4, or the heater 4 may be configured to be porous and able to perform at least part of the wicking function directly (a metallic mesh, for example). In the present example, the system is an electronic system, and the heater 4 may comprise one or more electrical heating elements that operate by ohmic/resistive (Joule) heating, although inductive heating may also be used, in which case the heater comprises a susceptor in an induction heating arrangement. A heater of this type could be configured in line with the examples and embodiments described in more detail below. In general, therefore, an atomiser or aerosol generator, in the present context, can be considered as one or more elements that implement the functionality of a vapour-generating element able to generate vapour by heating source liquid (or other aerosol-generating material) delivered to it, and a liquid transport or delivery element able to deliver or transport liquid from a reservoir or similar liquid store to the vapour-generating element by a wicking action/capillary force or otherwise. An aerosol generator is typically housed in an article 30 of an aerosol generating system, as in FIG. 1, but in some examples, at least the heater part may be housed in the device 20. Embodiments of the disclosure are applicable to all and any such configurations which are consistent with the examples and description herein.

Returning to FIG. 1, the article 30 also includes a mouthpiece or mouthpiece portion 35 having an opening or air outlet through which a user may inhale the aerosol generated by the heater 4.

The device 20 includes a power source such as cell or battery 7 (referred to hereinafter as a battery, and which may or may not be re-chargeable) to provide electrical power for electrical components of the e-cigarette 10, in particular to operate the heater 4. Additionally, there is a controller 8 such as a printed circuit board and/or other electronics or circuitry for generally controlling the e-cigarette. The controller may include a processor programmed with software, which may be modifiable by a user of the system. The control electronics/circuitry 8 operates the heater 4 using power from the battery 7 when vapour is required. At this time, the user inhales on the system 10 via the mouthpiece 35, and air A enters through one or more air inlets 9 in the wall of the device 20 (air inlets may alternatively or additionally be located in the article 30). When the heater 4 is operated, it vaporises source liquid delivered from the reservoir 3 by the aerosol-generating material transfer component 6 to generate the aerosol by entrainment of the vapour into the air flowing through the system, and this is then inhaled by the user through the opening in the mouthpiece 35. The aerosol is carried from the aerosol generator 5 to the mouthpiece 35 along one or more air channels (not shown) that connect the air inlets 9 to the aerosol generator 5 to the air outlet when a user inhales on the mouthpiece 35.

More generally, the controller 8 is suitably configured/programmed to control the operation of the aerosol provision system to provide functionality in accordance with embodiments and examples of the disclosure as described further herein, as well as for providing conventional operating functions of the aerosol provision system in line with established techniques for controlling such devices. The controller 8 may be considered to logically comprise various sub-units/circuitry elements associated with different aspects of the aerosol provision system's operation in accordance with the principles described herein and other conventional operating aspects of aerosol provision systems, such as display driving circuitry for systems that may include a user display (such as a screen or indicator) and user input detections via one or more user actuable controls 12. It will be appreciated that the functionality of the controller 8 can be provided in various different ways, for example using one or more suitably programmed programmable computers and/or one or more suitably configured application-specific integrated circuits/circuitry/chips/chipsets configured to provide the desired functionality.

The device 20 and the article 30 are separate connectable parts detachable from one another by separation in a direction parallel to the longitudinal axis, as indicated by the double-headed arrows in FIG. 1. The components 20, 30 are joined together when the system 10 is in use by cooperating engagement elements 21, 31 (for example, a screw or bayonet fitting) which provide mechanical and in some cases electrical connectivity between the device 20 and the article 30. Electrical connectivity is required if the heater 4 operates by ohmic heating, so that current can be passed through the heater 4 when it is connected to the battery 5. In systems that use inductive heating, electrical connectivity can be omitted if no parts requiring electrical power are located in the article 30. An inductive work coil can be housed in the device 20 and supplied with power from the battery 5, and the article 30 and the device 20 shaped so that when they are connected, there is an appropriate exposure of the heater 4 to flux generated by the coil for the purpose of generating current flow in the material of the heater. The FIG. 1 design is merely an example arrangement, and the various parts and features may be differently distributed between the device 20 and the article 30, and other components and elements may be included. The two sections may connect together end-to-end in a longitudinal configuration as in FIG. 1, or in a different configuration such as a parallel, side-by-side arrangement. The system may or may not be generally cylindrical and/or have a generally longitudinal shape. Either or both sections or components may be intended to be disposed of and replaced when exhausted, or be intended for multiple uses enabled by actions such as refilling the reservoir and recharging the battery. In other examples, the system 10 may be unitary, in that the parts of the device 20 and the article 30 are comprised in a single housing and cannot be separated. Embodiments and examples of the present disclosure are applicable to any of these configurations and other configurations of which the skilled person will be aware, but are most generally concerned with configurations comprising an article with a refillable storage area

The present disclosure relates to the refilling of a storage area for aerosol generating material in an aerosol provision system, whereby a user is enabled to conveniently provide a system with fresh aerosol generating material when a previous stored quantity has been used up. It is proposed that this be done automatically, by provision of apparatus which is termed herein a refilling device, refilling unit, refilling station, or simply dock. The refilling device is configured to receive an aerosol provision system, or more conveniently, the article from an aerosol provision system, having a storage area which is empty or only partly full, plus a larger reservoir holding aerosol generating material. A fluid communication flow path is established between the reservoir and the storage area, and a controller in the refilling device controls a transfer mechanism or arrangement operable to move aerosol generating material along the flow path from the reservoir to the storage area. The transfer mechanism can be activated in response to user input of a refill request to the refilling device, or activation may be automatic in response to a particular state or condition of the refilling device detected by the controller. For example, if both an article and a reservoir are correctly positioned inside the refilling unit, refilling may be carried out. Once the storage area is replenished with a desired quantity of aerosol generating material (the storage area is filled or a user specified quantity of material has been transferred to the article, for example), the transfer mechanism is deactivated, and transfer ceases. Alternatively, the transfer mechanism may be configured to automatically dispense a fixed quantity of aerosol generating material in response to activation by the controller, such as a fixed quantity matching the capacity of the storage area.

FIG. 2 shows a highly schematic representation of an example refilling device. The refilling device is shown in a simplified form only, to illustrate various elements and their relationship to one another. More particular features of one or more of the elements with which the present disclosure is concerned will be described in more detail below.

The refilling device 50 may be referred to hereinafter for convenience as a “dock”. This term is applicable since a reservoir and an article are received or “docked” in the refilling device during use. The dock 50 comprises an outer housing 52. The dock 50 is expected to be useful for refilling of articles in the home or workplace (rather than being a portable device or a commercial device, although these options are not excluded). Therefore, the outer housing, made for example from metal, plastics or glass, may be designed to have an pleasing outward appearance such as to make it suitable for permanent and convenient access, such as on a shelf, desk, table or counter. It may be any size suitable for accommodating the various elements described herein, such as having dimensions between about 10 cm and 20 cm, although smaller or larger sizes may be preferred. Inside the housing 50 are defined two cavities or ports 54, 56. A first port 54 is shaped and dimensioned to receive and interface with a reservoir 40. The first or reservoir port 54 is configured to enable an interface between the reservoir 40 and the dock 50, so might alternatively be termed a reservoir interface. Primarily, the reservoir interface is for moving aerosol generating material out of the reservoir 40, but in some cases the interface may enable additional functions, such as electrical contacts and sensing capabilities for communication between the reservoir 40 and the dock 50 and determining characteristics and features of the reservoir 40.

The reservoir 40 comprises a wall or housing 41 that defines a storage space for holding aerosol generating material 42. The volume of the storage space is large enough to accommodate many or several times the storage area of an article intended to be refilled in the dock 50. A user can therefore purchase a filled reservoir of their preferred aerosol generating material (flavour, strength, brand, etc.), and use it to refill an article multiple times. A user could acquire several reservoirs 40 of different aerosol generating materials, so as to have a convenient choice available when refilling an article. The reservoir 40 includes an outlet orifice or opening 44 by which the aerosol generating material 42 can pass out of the reservoir 40. In the current context, the aerosol generating material 42 has a liquid form or a gel form, so may be considered as aerosol generating fluid. The term “fluid” may be used herein for convenience to refer to either a liquid or a gel material; where the term “liquid” is used herein, it should be similarly understood as referring to a liquid or a gel material, unless the context makes it clear that only liquid is intended.

A second port 56 defined inside the housing is shaped and dimensioned to receive and interface with an article 30. The second or article port 54 is configured to enable an interface between the article 30 and the dock 50, so might alternatively be termed an article interface. The article interface 56 is for receiving aerosol generating material into the article 30, and according to the present examples, the article interface enables additional functions, such as electrical contacts and sensing capabilities for communication between the article 30 and the dock 50 and determining characteristics and features of the article 30. In particular, the article interface 56 has associated with it an energy wave-based sensing or detecting system 59 (indicated highly schematically only in FIG. 2) which may be used by a controller 55 in the refilling dock 50 in order to obtain information about fluid in a storage area of the article 30 when received in the article interface 56.

The article 30 itself comprises a wall or housing 31 that has within it (but possibly not occupying all the space within the wall 31) a storage area 3 for holding aerosol generating material. The volume of the storage area 3 is many or several times smaller than the volume of the reservoir 40, so that the article 30 can be refilled multiple times from a single reservoir 40. The article also includes an inlet orifice or opening 32 by which aerosol generating material can enter the storage area 3. Various other elements may be included in the article, as discussed above with regard to FIG. 1. For convenience, the article 30 may be referred to hereinafter as a pod 30.

The housing 52 of the dock also accommodates a fluid conduit 58, being a passage or flow path by which the reservoir 40 and the storage area 3 of the article 30 are placed in fluid communication, so that aerosol generating material can move from the reservoir 40 to the article 30 when both the reservoir 40 and the article 30 are correctly positioned in the dock 50. Placement of the reservoir 40 and the article 30 into the dock 50 locates and engages them such that the fluid conduit 58 is connected between the outlet orifice 44 of the reservoir 40 and the inlet orifice 32 of the article 30. Note that in some examples, all or part of the fluid conduit 58 may be formed by parts of the reservoir 40 and the article 30, so that the fluid conduit is created and defined only when the reservoir 40 and/or the article 30 are placed in the dock 30. In other cases, the fluid conduit 58 may be a flow path defined within a body of the dock 52, to each end of which the respective orifices are engaged.

Access to the reservoir port 54 and the article port 56 can be by any convenient means. Apertures may be provided in the housing 52 of the dock 50, through which the reservoir 40 and the article 30 can be placed or pushed. Doors or the like may be included to cover the apertures, which might be required to be placed in a closed state to allow refilling to take place. Doors, hatches and other hinged coverings, or sliding access elements such as drawers or trays might include shaped tracks, slots or recesses to receive and hold the reservoir 40 or the article 30, which bring the reservoir 40 or the article 30 into proper alignment inside the housing when the door etc. is closed. These and other alternatives will be apparent to the skilled person, and do not affect the scope of the present disclosure.

The dock 50 also includes an aerosol generating material (“liquid” or “fluid”) transfer mechanism, arrangement, apparatus or means 53, operable to move or cause the movement of fluid out of the reservoir 40, along the conduit 58 and into the article 30. Various options are contemplated for the transfer mechanism 53.

As already noted, a controller 55 is also included in the dock 50. This is operable to control components of the dock 50, in particular to generate and send control signals to operate the transfer mechanism. As noted, this may be in response to a user input, such as actuation of a button or switch (not shown) on the housing 52, or automatically in response to both the reservoir 40 and the article 30 being detected as present inside their respective ports 54, 56. The controller 55 may therefore be in communication with contacts and/or sensors (such as the sensing system 59, but otherwise not shown) at the ports 54, 56 in order to obtain data from the ports and/or the reservoir 40 and article 30 that can be used in the generation of control signals for operating the transfer mechanism 53. The controller 55 may comprise a microcontroller, a microprocessor, or any configuration of circuitry, hardware, firmware or software as preferred; various options will be apparent to the skilled person.

Finally, the dock 50 includes a power source 57 to provide electrical power for the controller 53, and any other electrical components that may be included in the dock, such as sensors, user inputs such as switches, buttons or touch panels, and display elements such as light emitting diodes and display screens to convey information about the dock's operation and status to the user. Also, the transfer mechanism may be electrically powered. Since the dock may be for permanent location in a house or office, the power source 57 may comprise a socket for connection of an electrical mains cable to the dock 50, so that the dock 50 may be “plugged in”. Alternatively, the power source may comprise one or more batteries, which might be replaceable or rechargeable, in which case a socket connection for a charging cable can be included.

Further details relating sensing of a fluid amount in the storage area of the article, for example for use in the control of the filling of the storage area, will now be described.

As noted above, the filling process is governed by the controller of the refilling device, and includes the generation and sending of control signals to the transfer mechanism to cause it to manage the movement of fluid from the reservoir into the storage area of an article received in the article interface. This can be performed so as to dispense a fixed amount of fluid that corresponds to the known capacity of the article's storage area or a known required amount of fluid, after which operation of the transfer mechanism ceases. Alternatively, and in some situations more usefully, commencement and/or cessation of the fluid dispensing can be implemented in response to ascertainment, determination or detection of a fluid level or amount in the storage area of the article. The controller may be configured to determine that the storage area is empty, or is only partially full, and commence filling in response. Similarly, the controller may be configured to recognise when the storage area has become full, or otherwise filled to a required level, and to cause the transfer mechanism to stop transferring fluid in response. This allows an article to be refilled safely without spilling or pressure build-up in the storage area, regardless of an amount of fluid present in the article at the start of the refilling process. Articles can hence be topped up as well as completely or partially refilled from empty.

In the present disclosure, it is proposed to use an energy wave-based fluid detecting or sensing system, apparatus or arrangement to determine information about an amount of fluid in the storage area of an article received in a refilling device. The information may comprise a volume of fluid, or the position or location of the surface of the fluid relative to the storage area, or the absence of a fluid surface if the storage area is empty, indicating the level of the fluid within the storage area, the presence or absence of fluid in the storage area, or the proportion or percentage of full capacity represented by a current quantity of fluid. In response to the information, the controller can commence filling, fill continuously until a full status of the storage area is ascertained, or perform a filling action to dispense a particular fixed amount of fluid determined from the size of the empty volume of the storage area.

Fluid detecting systems that require sensing through the walls of the article, which may comprise both the outer housing of the article and the separate walls of the storage area within the article, or a single shared wall or walls for article designs where the outer housing also defines at least part of the storage area, can be prone to errors, since the presence of the walls must be taken into account and can interfere with the sensing. The walls may absorb or deflect energy waves used for sensing so that a reduced amount of energy reaches the interior of the storage area. For capacitance-based sensing, the walls will be present within the sensing region and contribute to the sensed capacitance value. Hence, the sensing should be calibrated for the presence of the walls. However, manufacturing errors and variations can cause deviations in the wall thickness from an intended value, so that more or less wall material may be present for a particular article than has been calibrated for, giving sensing errors. Damage to the walls, or the presence of dirt or debris on the exterior of the article, can have a similar effect. Damage and dirt can also affect the accuracy of sensing systems that utilise external electrical contacts on an article. Optical sensing systems require at least part of the walls surrounding the fluid to be transparent to the optical wavelength used, which places limitations on article design.

To address these issues, it is proposed herein to perform fluid detection along an unimpeded pathway through air into the interior of the storage area of a received article. The drawbacks associated with the presence of walls within the sensing region are thereby avoided. An unimpeded pathway can be implemented by making use of an orifice in the wall or walls surrounding the storage area (which may be single wall of the article's outer housing which is shared with the storage area, or separate walls defining the storage area inside the outer housing, as noted above) which is provided for the venting of air out of the storage area during filling. The provision of venting during filling is useful to enable more efficient ingress of fluid and to reduce leakage. The incoming fluid will displace the air in the empty or partially empty storage area, and in the absence of venting of the air to the exterior of the article, this will produce a pressure increase inside the storage area, causing leaks and inhibiting the ingress of further fluid so that an article may be imperfectly filled. Allowing the egress of air enables pressure equalisation within the storage area so that fluid is not forced out and/or incoming fluid can flow in more effectively. Hence, it is beneficial to provide one or more orifices in the storage area through which air can vent during filling. The orifice or orifices may be a dedicated venting orifice, or may be a shared orifice for both the inflow of fluid and the outflow of air.

When the orifice is open for venting, during a filling action while the article is received in the article interface, an unimpeded free space pathway through air is provided between the exterior environment of the article and the interior of the storage area. This may be considered to be a venting pathway or venting channel. It is proposed to direct energy waves from an energy source located within the refilling device and externally to the received article through the orifice and into the interior of the storage area. The energy waves interact with the interior of the storage area, that is with any fluid therein and/or with one or more walls defining the storage area, and at least a proportion of the incoming energy is returned outwardly through the orifice. The returned energy will contain information about the interior of the storage area, having undergone reflection, absorption, diffraction, dispersal or similar via an interaction with the interior of the storage area. Hence, the returned energy will have one or more properties of characteristics that vary with the storage area interior and hence according to the presence, absence or amount of fluid which is present in the storage area. Therefore, a detector is provided, also located within the refilling device and externally to the received article, positioned so as to detect the returned energy waves, and configured to generate a corresponding detector output representing the returned energy, and therefore also carrying information about the interior of the storage area. The detector output is delivered to the controller, which is configured to process the detector output to retrieve or ascertain the relevant property or characteristic of the detected returned energy and determine from it information about the amount of fluid in the storage area. This information can then be used by the controller to generate appropriate control signals to operate the fluid transfer mechanism of the refilling device and thereby implement a filling action.

The orifice used from venting should be configured so as to be closed during normal use of the article within an aerosol provision system, so that fluid does not leak from it. Therefore, depending on the configuration of the orifice, it may be necessary for the refilling device to be configured to open the orifice when the article is received in the article interface, in order to establish a venting pathway for the outflow of air, and for transit of the inwardly directed energy waves from the energy source and the outwardly directed energy waves returning to the detector.

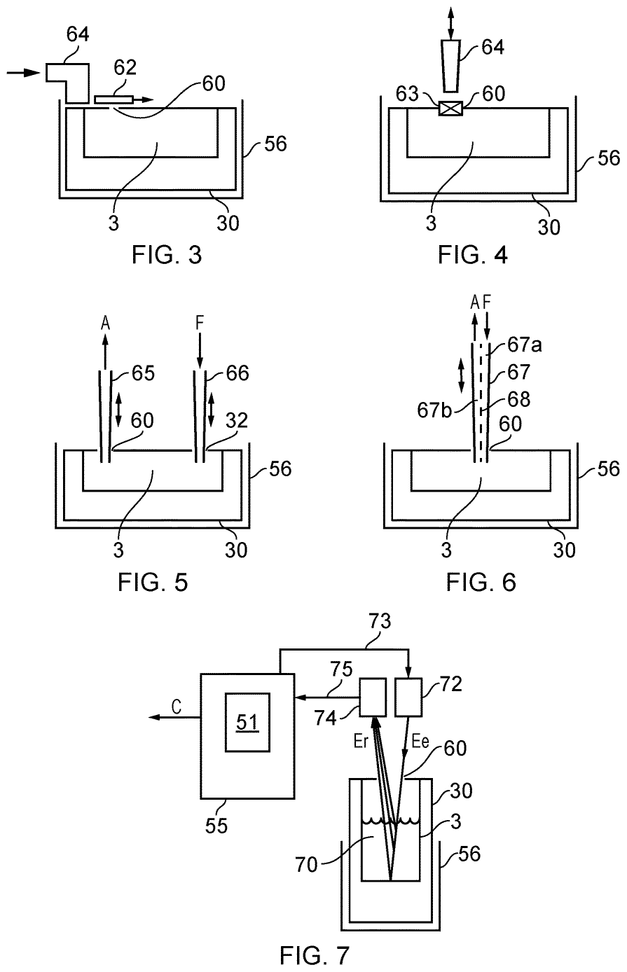

FIG. 3 shows a highly simplified schematic side view of a first example article with a suitable orifice. The article 30, having an storage area 3 for fluid is received in an article interface 56 in a refilling dock (details of which are omitted for simplicity). The article 30 comprises an orifice 60 for venting, in a common wall defined by the outer housing of the article 30 which also forms a wall of the storage area 3. Other components of the article are omitted for clarity, such as a fluid inlet orifice for fluid to be delivered into the storage area during a filling action). The various components are not shown to scale. Also, the article 30 is depicted is a generally horizontal orientation, with the orifice 60 in an uppermost wall as the article 30 is received in the article interface 56. The article interface 56 is shown as comprising a base wall and side walls, with an open upper face for access to the article 30. However, these are example configurations only and are not limiting in any way. The article 30 may be differently sized, shaped and configured, as may the article interface 56, and the article 30 may be received in the article interface 56 in different orientation.

The orifice 60 has an associated cover 62 configured to seal the orifice 60 when the article 30 is not in the article interface 56. The cover 62 may therefore comprises sealing elements or be otherwise tightly fitting over the orifice 60. The cover 62 is attached to the housing of the article 30 in movable manner, such as by a hinge, a pivoting joint or slidably mounted, in order that it can be moved from over the orifice 60 (indicated by the small arrow) in order to open the orifice 60 and provide a pathway for venting and for the input and return of the sensing energy waves. The refilling device comprises an opening mechanism 64 configured to engage with the cover 62, such as by pushing or pulling or by magnetic attraction, indicated generally by the bold arrow) in order to move the cover 62 into a position in which the orifice 60 is open (not shown). The opening mechanism 64 may be further configured to move the cover 62 back its position covering or closing the orifice 62 after use, if appropriate, in other words, if the cover 62 lacks any means to return itself to the closed position without positive action of the opening mechanism 64 (such as being spring-mounted or resilient in some way that returns it to the closed position once the opening mechanism is disengaged from the cover 62).

The opening mechanism 64 may be under control of the controller (not shown) of the refilling device in that the controller is configured to cause appropriate movement or other action of the opening mechanism 64, such as by generating and sending control signals to an electrically operated opening mechanism 64, when the article is first received in (and before it is removed from) the article interface 56. Alternatively, mechanical engagement may be used, such that the opening mechanism 64 is configured to engage with and act on the cover 62 as the article is moved into the article interface 56, or if the article interface 56 itself is moved relative to the refilling device to place the article 30 into a correct position for refilling.

FIG. 4 shows a highly simplified schematic side view of a second example article with a suitable orifice. In this example the article comprises an orifice 60 as before, where in this example the orifice 60 is occupied by or otherwise comprises a valve 63. The refilling device again comprises an opening mechanism 64, which in this example is aligned with and configured for movement towards the valve 63 (for example under control of the controller as before) in order to engage with the valve and push it open), and movement away from the valve 63 to allow the valve 63 to close after use. The double-headed arrow indicates motion of the opening mechanism 64. Opening of the valve 63 opens the orifice 60 for venting and to provide the energy wave pathway. Accordingly the valve may comprise any suitable design of valve able to be opened and closed in this way, or a similar way.

Alternatively, the opening mechanism 64 may be static, and in alignment with the valve, such that placement of the article 30 into the article interface or a movement of the article interface 56 within the refilling dock brings the valve 63 into engagement with the opening mechanism 64.

FIG. 5 shows a highly simplified schematic side view of a third example article with a suitable orifice. The article 30 is again shown received in an article interface, with the orifice 60 for venting in its upper wall. The orifice 60 comprises a valve or other closure (not shown) which when opened allows venting and provide a pathway for the energy waves for fluid sensing. In this example the refilling dock (not shown) comprising a venting nozzle 65 in the form of a hollow tube which is movable relative to the article 30 in order to engage and disengage with the orifice 60 (indicated by the double-headed arrow). The venting nozzle 65 is shown in an engaged position, in which the hollow interior of the venting nozzle provides a channel extending between the interior of the storage area 3 and the exterior of the article 30, through which air A can pass in order to leave the storage area 3 as it is displaced by incoming fluid during filling. Also, the channel defined by the venting nozzle 65 provides a pathway along which the energy waves can be directed from the energy source (not shown) and returned to the detector (not shown) for fluid detection or sensing.

Also shown in this example is a second orifice in the storage area 3 of the article 30, being a fluid inlet orifice 32 as already described with respect to FIG. 2. The refilling device comprises a hollow fluid nozzle 66 movable relative to the article 30 for engagement and disengagement with the inlet orifice 32. When engaged with the inlet orifice 32 the fluid nozzle 32 opens the fluid orifice 32 and the hollow interior provides a channel or flow path for fluid F delivered from the reservoir (not shown) to enter the storage area 3, and therefore forms part of the fluid communication flow path described with respect to FIG. 2. Although not described or shown in FIGS. 3 and 4, a similar fluid delivery arrangement and fluid orifice may be provided in conjunction with other venting orifice configurations.

The movement of the venting nozzle 65 and the fluid nozzle 66 are relative to the article 30, and may be implemented by movement of the nozzles 65, 66 towards and away from the article 30, by movement of the article 30 (by being carried by the article interface 56) towards and away from the ends of the nozzles 65, 66, or both. The movement may be under control of the controller (not shown) which generates and transmits suitable control signals to one or more movement mechanisms (not shown).

FIG. 6 shows a highly simplified schematic side view of a fourth example article with a suitable orifice. In this example the article 30 comprises a single orifice 60 for the storage area configured for the egress of air and the ingress of fluid. The refilling device (not shown) comprises a single hollow nozzle 67 configured for relative movement with respect to the article 30 for engagement and disengagement with the orifice 30, as described with regard to FIG. 6. In this example, however, the nozzle 67 comprises one or more longitudinal interior walls which divide the hollow space inside the nozzle into a first channel 67a, for the delivery of fluid F into the storage area 3, as part of the fluid communication flow path from the reservoir (not shown), and a second channel 67b that acts as a venting channel for air A to vent from the storage area 3 to the exterior of the article 30, and to provide a pathway for the direction and return of energy waves for fluid sensing.

FIG. 7 shows a highly simplified schematic side view of part of an example refilling device configured for fluid sensing or detection as proposed herein. An article 30 with an orifice 60 for venting air from the storage area 3 is shown received in the article interface 56 of the refilling device. Closures, valves, orifice opening arrangements and fluid delivery arrangements such as those described with regard to FIGS. 3-6 are omitted for clarity. The refilling device comprises an energy source 72 operable to emit energy waves Ee for sensing.

The energy source is configured (possibly via one or more beam shaping elements, not shown) to emit the energy waves Ee in directional manner (such as a focussed or collimated beam) such that the emitted energy waves Ee are directed through the orifice 60 and into the interior of the storage area 3. The energy source 72 may be under control of the controller 55 of the refilling device, such as via control signals sent along a control line 73 such that the energy source 72 can be caused to emit energy waves Ee at a proper time, when fluid sensing is required.

When inside the storage area, the energy interacts with one or more parts of the storage area 3 and any fluid 70 therein and at least part of the energy creates return energy waves Er, via reflection or other interaction with the fluid surface, the main body of the fluid and/or one or more walls of the storage area in a propagation direction towards the orifice 60. The returned energy waves Er exit the storage area 3 through the orifice 60. The refilling device comprises a detector 74 configured to detect the returned energy waves Er, possibly via one or more energy collection or directing elements such as lenses, not shown), and produce an output signal corresponding to the detected returned energy waves Er (for example as instantaneous power measurements or a distribution of power over time or over space). The output signal is provided to the controller via a signal line 75.

The controller 55 receives the detector output. The controller 55 comprises a processor 51 or similar configured (such as by suitable programming) to process the detector output and determine from it information about the amount of fluid present in the article's storage area. As noted above, the presence and amount of fluid in the storage area will modify the nature of the returned energy Er (such as the amount returned or the time at which it is returned) so that the returned energy Er, and consequently the output of the detector, carry information regarding the amount of fluid in the storage volume (such as volume, depth or surface level position), which is extracted, ascertained or determined from the detector output by the processor 51. The controller 55 can then generate control signals C to operate a filling action of the refilling device to move fluid into the storage area 3. For example, a filling action can be started when an article 3 is first placed in the article interface 56 and the controller determines that the amount of fluid is less than a full amount for that article, so that refilling is needed. A filling action can be continued if the controller determines that a current amount of fluid achieved by filling remains less than a full amount for that article. A filling action can be stopped if the controller determines that a current amount of fluid achieved by filling is equal to or greater than a full amount for that article. A filling action to deliver a fixed amount of fluid can be implemented if the controller determines, from a current amount of fluid determined when an article is first placed in the article interface, the amount of fluid required to achieve a full amount.

In some embodiments, the energy waves utilised are in the form of light (which may be visible, infrared or ultraviolet), so that the energy source comprises an optical source configured to emit light as a beam or configurable into a beam via beam shaping optics such as mirrors and/or lenses. For example, the optical source may comprises a light emitting diode or a laser diode. The detector then comprises an optical detector configured to detect light having the characteristics of the returned light from the interior of the storage area of an article. Typically, this will be light of the same wavelength as the light emitted by the optical source, but in cases where the fluid in the storage area may contain a material that emits light under the action of incident light, or otherwise causes a wavelength shift or spectral change in returned light, at least a portion of the returned light may be of a different wavelength from the emitted light, and the optical detector should be configured accordingly. The optical detector may be provided with one or more filters to block ambient light or light from other sources so that only the required returned light is detected.

Light may be utilised in a variety of ways to determine an amount of fluid in the storage area of an article. For example, the orientation of the emitted and received light relative to the fluid in the storage area enables different interactions of the light with the interior of the storage area. Some examples will now be discussed.

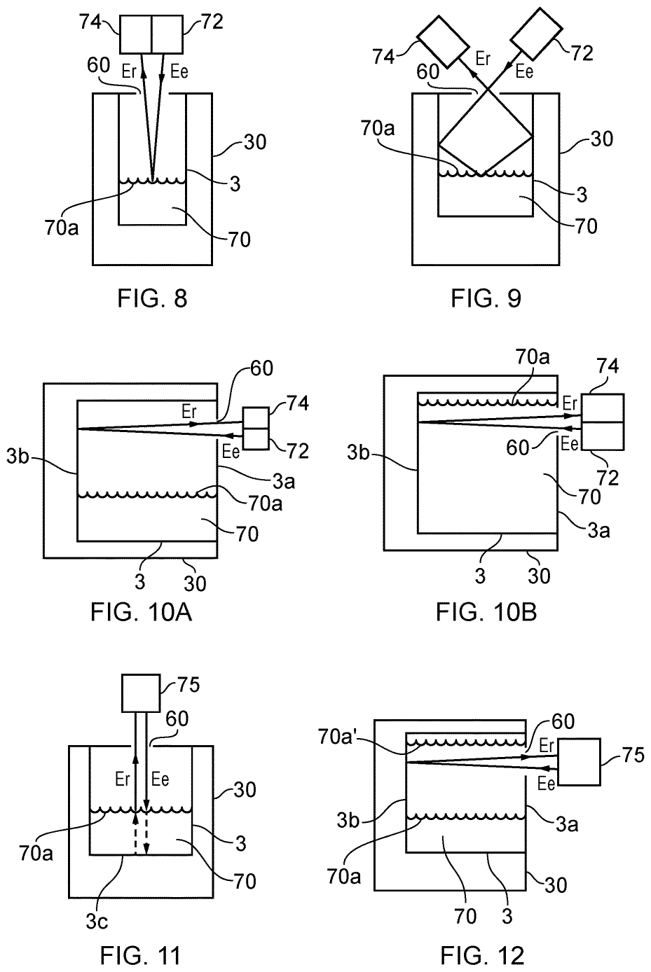

FIG. 8 shows a simplified schematic view of a first example of a light-based fluid sensing system. For simplicity, only the article 30, the optical source 72 and the optical detector 74 are shown. The article 30 has an orifice 60 for venting air from the storage area 3 and for transmission of light emitted from the optical source 72 and returned to the optical detector 74, as before. The optical source 72 and the optical detector 74 are arranged so that at least a portion of the light Ee emitted from the optical source 72 is returned to the optical detector 74 by being directly reflected from a surface 70a of fluid 70 in the storage area 3. In particular, in this example, the article 30 is arranged with the orifice 60 in its uppermost wall, and the optical source 72 and the optical detector 74 are positioned such that light is directed through the orifice 60 into the storage area and onto the surface 70a of the fluid 70 and returned from the surface 70a back through the orifice 60 to the optical detector 74 along substantially vertical optical propagation paths. This is required owing to the typically small width of the orifice 60, that allows a very small or zero angle between the path of the emitted light Ee and the path of the returned light Er if light reflected directly from the surface 70a is to be detected. The vertical or near vertical light propagation also requires that the optical source 72 and the optical detector 74 are located immediately adjacent to one another, or coincident with one another. Alternatively, coincident beam baths can be achieved by use of a beam splitter (not shown) arranged at a 45 degree angle to transmit (or reflect) the emitted beam of light Ee from the optical source 72 and to reflect (or transmit) the returned beam of light Er to the optical detector 74; this allows the optical source 72 and the optical detector 74 to be located at spaced apart locations.

A configuration where the detected light is that light returned by direct reflection from the surface 70a of the fluid 70 allows the amount of fluid in the storage area 3 to be determined from optical time of flight measurements. The optical source 72 is configured to emit light Ee as a short pulse of light, of brief duration in time. The pulse propagates from the optical source 72 through the orifice 60 and into the interior of the storage area 3. The pulse is reflected from the surface 70a of the fluid 70 (or from the base wall of the storage area 3 in the event there is no fluid present) and at least a portion of the energy of the pulse is returned back through the orifice 60 as the returned light Er for detection at the optical detector 74. Since the pulse is a discrete event in time, the period of time that has elapsed between emission of the pulse and detection of the pulse can be determined, such as by the controller of the refilling device triggering pulse emission from the optical source and running a clock until the returned pulse is detected at the optical detector. Since the speed of light in air is a known constant, and the pulse propagation time is measured, the distance travelled by the pulse between source and detector can be calculated, as is well-known in optical time-of-flight measurements. Since the pulse propagation distance depends on the position of the surface 70a of the fluid 70, the height of the surface 70a within the storage area, corresponding to the amount of fluid 70, can be determined by the controller.

FIG. 9 shows a simplified schematic view of a second example of a light-based fluid sensing system. As in the previous example, the article 30 is arranged with its orifice 60 uppermost, although this is not essential. The optical source 72 is positioned to direct a beam of emitted light Ee (possibly via beam shaping and directing optics, not shown) through the orifice 60 into the interior of the storage area 3, and the optical detector 74 (again possibly via beam collecting and directing optics, not shown) is positioned to detect light Er returned from the interior of the storage area 3 via the orifice 60. However, the optical detector 74 is positioned so as to be able to detect light which has returned via one or more optical propagation paths which are not a direct reflection of the emitted light Ee from the surface 70a of the fluid 70. Hence, the emitted light Ee is directed into the orifice 60 along an oblique angle, and the optical detector 74 can be configured to detect returned light Er that has followed more than one path within the interior of the storage area 3, which can arise from splitting and refraction of light as it interacts with various surfaces inside the storage area 3. One example path is shown. The incoming emitted light Ee is incident at an angle on a side wall of the storage area, from which it is reflected, at an angle to the surface 70a of the fluid, from which it is reflected, at an angle, to the opposite side wall of the storage area 3, from which it exits the storage area 3 via the orifice 60 and is collected by the optical detector 74. It will be apparent that other optical paths (not shown) will also arise. For example, not all the incident light will be reflected at the fluid surface 70a. A proportion will be refracted into the fluid and propagate through the fluid, where some of the optical power may be absorbed, the light possibly also undergoing scattering from any scattering centres in the fluid en route, to the base wall of the storage area where some of the light will be reflected from the base wall. It will be appreciated that in this way, a plurality of simultaneous different optical paths can arise within the storage area 3, followed by different proportions of the power of the initial emitted light Ee, that together make up the returned light Er reaching the optical detector 74, which will comprise only a proportion of the originally emitted optical power. It will further be appreciated that the various interactions experienced along the different optical paths will depend on the position of the surface 70a of the fluid, and corresponding proportions of the interior of the storage area 3 which are respectively occupied by air and by fluid. Hence, the total amount of the optical power in the returned light Er can vary with the depth of fluid 70 in the storage area 3. Accordingly, the controller of the refilling device, by considering the output of the optical detector, corresponding to the detected optical power, can determine an amount of fluid in the storage area 3 if the controller is provided with a relationship between detected power and fluid amount (fill level in the storage area) for the article. The relationship may be embodied in an equation or a mapped in a stored look-up table, for example.

In this example, the optical source may be configured to emit pulses of light, and the controller can acquire power measurements from the detector for each pulse, accumulate power measurements from a plurality of pulses, or acquire power periodically for only some pulses, for example regularly for every nth pulse. In any of these cases, the optical source may be configured to emit a continuous sequence of pulses for all or part of a refilling action. Alternatively, the controller may trigger pulse emission periodically as required.

In a further alternative, the optical source may be configured as a continuous wave optical source, to emit a constant continuous power level of light. The controller may continuously monitor the power measurement output by the detector, or may acquire discrete power measurements at regular or irregular intervals during a refilling action.

Both the FIG. 8 and FIG. 9 examples allow the controller to determine an amount of fluid in the storage area for any amount between an empty storage area (zero fluid amount) and a full storage area (maximum fluid amount). The determined amount may be monitored continuously over the course of a filling action, or polled at regular or irregular intervals over a filling action to obtain a series of discrete measurements of the fluid amount, such as at least two, or just two measurements might be made, such as initially before or at the start of a filling action, and again towards the expected end of a filling action, when it is expected that a required volume of fluid will have been delivered into the storage area, based on a known rate of fluid delivery, the initial measurement and a desired refilled level, which may be a full or partially full storage area, in order to check that the filling action is complete. Hence, the controller may be configured to determine information about the amount of fluid in the storage area continuously during filling, or to determine information about the amount of fluid in the storage area periodically during filling, for example two or more times.

The FIG. 8 and FIG. 9 embodiments use reflection (directly and indirectly, respectively) from a surface of the fluid to determine fluid amount. It is also possible to obtain information about the amount of fluid without fluid surface reflection, using instead the different interaction of emitted light with fluid and with the interior wall surfaces of the storage area.

FIG. 10A shows a FIG. 9 shows a simplified schematic view of a third example of a light-based fluid sensing system. In this example, the article 30 is oriented with the orifice 60 in a side wall 3a of the storage area 3, located near the upper wall of the storage area 3. The optical source 72 is arranged so that the emitted light Ee is directed through the orifice 60 so as to propagate through the interior of the storage area 3 along a propagation path which is substantially horizontal, and therefore parallel, substantially parallel, or near-parallel to the surface 70a of any fluid 70 in the storage area. The optical detector 74 is arranged to receive returned light Er propagating along the same or a similar propagation path, which the returned light Er arising from reflection of the emitted light Ee by the interior surface of the opposite side wall 3b of the storage area 3, that is, the side wall 3b opposite to the side wall 3a containing the orifice 60. The opposite side wall 3b is substantially orthogonal to the emitted light Ee propagation direction so that light reflected from it returns towards the orifice 60 and is able to leave the storage area 3 for detection by the optical detector 74. As with the FIG. 8 example, the emitted light Ee and the returned light Er follow coincident or near-coincident paths, so the optical source 72 and the optical detector 74 must be adjacent to one another, or coincident, or optical elements such as a beam splitter can be used to arrange the light along the required paths.

In FIG. 10A, the storage area 3 is shown with a low level (small amount) of fluid 70 within it, so that the 70a of the fluid 70 lies below the orifice 60. Hence, the emitted light Ee propagates through air in the space inside the storage area 3 above the volume occupied by the fluid 70, until it is incident on the opposite wall 3b, where it undergoes reflection. The proportion of the incident emitted light Ee which become the returned light Er depends on the reflective properties of the surface of the opposite wall 3b, giving a first power level or value P1 for the returned light Er which is detected by the optical detector 74 and output to the controller of the refilling device.

FIG. 10B shows the same arrangement of light-based fluid sensing as in FIG. 10A, but with the storage area 3 full or near-full of fluid 70 so that the surface 70a of the fluid 70 is higher than, or above, the orifice 60. Therefore, the emitted light Ee enters the interior of the storage area 3, and has a propagation path through the fluid 70 in order to reach the opposite wall 3b. The emitted light Ee will experience some optical loss as it propagates through the fluid 70, such as by absorption and/or scattering, so a lower amount of light will reach the opposite wall 3b than in the FIG. 10A situation where the light propagates in air. The presence of the fluid will likely modify the reflection properties of the opposite wall so that the proportion of the emitted light Ee that is reflected into the returned light Er will also be different from in the FIG. 10A situation. The returned light Er will also experience optical loss as it travels through the fluid 70 from the opposite wall 3b to the orifice 60 and the optical detector 74. Hence, the returned light Er will have a different optical power level or value P2 than in the propagation through air situation of FIG. 10B, where likely P2 is less than P1, and may even be zero or below a detectable level if the optical loss is very high. Accordingly, a different power level P2 is detected by the optical detector 74 and output to the controller.

Therefore, there is a first optical power level P1 of the returned light Er detected for fluid levels below the height of the orifice 60, and second different optical power level P2 of the returned light Er detected for fluid levels at or above the height of the orifice 60. Since the orifice 60 is located high up in the side wall 3a of the storage area 3, it can be considered that fluid amounts with a surface level below the orifice correspond to the storage area being not full, and fluid amounts with a surface level at or above the orifice correspond to the storage area being full. The two different power values P1 and P2 are produced in the returned light Er for the “not full” and “full” fluid amounts in the storage area 3. Hence, the controller, by assessing the power value output by the optical detector 74, is able to determine information about the amount of the fluid 70 in the storage area 3, and determine if the storage area is “full” or “not full”. The controller can control a filling action of the refiling device accordingly, such as by initiating and continuing to operate the filling action when the detected power level indicates “not full”, and stopping the filling action when the detected power level indicates “full”.

It is possible that other properties or characteristics of the light are changed by the presence of the fluid in the optical paths when the storage area is full. The fluid may contain some material, such as a fluorescent emitter or a wavelength-specific absorber, that causes some form of spectral change or shift, so that a difference in detected wavelength of the returned light or a change in power at one or more allocated wavelengths will indicate that fluid is present or absent above the orifice position. The fluid may have optical dispersive properties that cause wavelength dependent-delays in propagating light, so that if the emitted light has the form of optical pulses, the length of the pulses of the returned light depend on the presence or absence of fluid along the propagation path. The surface of the opposite wall may have some property such that the different optical interfaces where fluid is absent or present produces a time or wavelength difference in the reflected light in addition to or instead of a change in reflected power level.

Therefore, if the refilling device is intended for use with a particular type of article and/or a particular type of fluid, the characteristics and properties of the returned light corresponding to a “not full” and a “full” storage area can be determined in advance, and the signatures of the returned light as values of power, time and/or wavelength for the different fill statuses can be stored in memory of the controller. In order to determine information about the amount of fluid in the storage area, the controller can compare an output from the detector to the stored signatures and classify the output as corresponding to “full” or “not full”. In a simpler form, only the expected output for one of “full” or “not full” may be stored, and the controller may find a match or no match for a detected output, where a match indicates the fluid amount for which the expected output is stored, and any non-matching output is classified as the fluid amount for which no expected output is stored. Alternatively, if it is known that in general, for specific articles and fluids, or a group of articles and fluids, there is large difference in one or more characteristics of the returned light for “not full” and “full” storage areas, a threshold for a value of one or more characteristics which is intermediate between the value correspond to “not full” and “full” can be set in advance and stored in the controller. In this case, the controller can determine information about the amount of fluid in the storage area by comparing the detector output with the threshold and ascertaining a “full” or “not full” storage area in accordance with the output having a value above/below or below/above the threshold. Hence, the controller can be configured to determine the amount of fluid by recognising or identifying a characteristic or property of the returned light detected by the optical detector which is caused by the fluid being present at the level of the orifice (fluid at or above the orifice).

This configuration allows a minimal number of fluid sensing measurements to be made, since the controller can definitely determine from a single measurement whether the storage area is full or not full. Hence, it may be sufficient to perform one initial measurement to determine that the storage area is not full and initiate a filling action in response, and one or a few further measurements at a later time to ascertain that the storage area is now full so that filling action can be terminated.

As an alternative, that does not require advance predetermined information about the optical properties of returned light for fluid amounts above and below the orifice, the controller can perform continuous monitoring or repeated and frequent periodic monitoring of the fluid amount during a filling action. If it is assumed that an article received in the article interface will be at least partially empty so that initial measurements of the fluid amount will be for light propagating in air, the appearance of fluid in the optical path as the storage area is filled and the fluid surface reaches the height of the orifice will produce a detectable change in the returned light. Hence, if the optical source is continuously emitting light into the storage area or emitting pulses of light on a frequent basis, the controller may be configured to simply monitor the output of the optical detector for a change, such as a power level change or a spectral shift or change. When a change is detected, the controller identifies this as the fluid surface reaching the height of the orifice and the optical propagation paths, and designates this as the amount of fluid in the storage area being a “full” amount. Hence, the controller can be configured to determine information about the amount of fluid in the storage area by recognising or identifying a change in the returned light that is caused by the surface of the fluid in the storage area reaching the orifice. To obviate errors and mis-identifications, the controller might be provided with a threshold value for the change, so that a change in the returned light must be at larger than the threshold in order to be identified as the storage area reaching a “full” fluid amount. For similar reasons, the storage area and/or the fluid might be configured to maximise the change in the returned light that occurs when fluid is present in the optical paths, such as the fluid having a high optical absorption for the wavelength(s) of the emitted light, or the inner surface of the opposite wall having a first reflectivity for an interface with air which is significantly from a second reflectivity for an interface with the fluid.

The FIGS. 10A and 10B embodiment essentially enable two different fluid amounts or fill statuses of the storage area to be distinguished, corresponding to fluid amounts above or below the height of the orifice. The fluid amounts which can be distinguished can be selected by choosing the height of the orifice along the side wall of the storage area, although it may be considered to be most useful for the orifice to be high up as in FIGS. 10A and 10B so that it can be recognised that the storage area is full or close to full. This arrangement is in contrast to the FIGS. 8 and 9 embodiments which provide a continuously varying optical response in the returned light as the height of the fluid surface level changes, so that all values of fluid amount between full and empty can be measured or identified.

The examples of FIGS. 8, 9, 10A and 10B have utilised energy waves in the form of light. The disclosure is not limited in this way, however, and in some other embodiments, the energy waves utilised are in the form of ultrasound. Hence, the energy source comprises an ultrasound source configured to emit ultrasound waves and arranged to direct ultrasound waves through the orifice in the storage area of an article and into the interior of the storage area. The detector comprises an ultrasound detector configured and arranged to detect ultrasound waves returned from the interior of the storage area, and to generate an output corresponding the detected ultrasound waves, which is passed to the controller for processing in order for the controller to determine information about the amount of fluid in the storage area.

FIG. 11 shows a highly simplified schematic view of a first example of an ultrasound-based fluid sensing system. The article 30 is arranged with the orifice 60 in the uppermost wall of the storage area 3. The ultrasound source and the ultrasound detector may be implemented as separate units, but may be implemented as shown to be comprised in a single ultrasound transducer unit configured to perform both ultrasound emission and ultrasound detection functions. The ultrasound transducer is arranged to emit ultrasound waves Ee that pass through the orifice 60 in a generally downward direction, so as to be directed along a propagation path that is substantially orthogonal to the surface 70a of fluid 70 in the storage area 3. A portion of the energy of the ultrasound waves will be reflected from the fluid surface 70a in a substantially reverse direction to the incident direction of the emitted waves Ee, back towards the orifice 60. A further portion of the energy of the emitted ultrasound waves Ee will pass through the fluid surface 70a and propagate through the fluid 70 to the base wall 3c of the storage area 3, where a portion of incident energy will be reflected in the substantially reverse direction, back towards the orifice 60. The portions of reflected ultrasound from the fluid surface 70a and the base wall 3c directed towards the orifice make up the returned ultrasound waves Er, and are detected by the ultrasound transducer 75. The returned ultrasound waves therefore comprise a component reflected from the fluid surface 70a and a component reflected from the base wall 3c, which can be distinguished, in the usual manner of detecting boundaries in ultrasound imaging. The transducer generates and sends an output signal representing the returned and detected ultrasound waves to the controller of the refilling device. The controller is configured to process the output signal and distinguish at least the part of the returned waves that arises from the reflection at the fluid surface 70a. Since the transducer 75 and the base wall 3c have fixed locations, the controller can determine a distance or position for the fluid surface 70a relative to the transducer 75 and/or the base wall 3c, and thereby determine a depth of the fluid in the storage area, in other words, information about the amount of fluid in the storage area.

The controller can then generate control signals for delivering fluid into the storage area in a refilling action, as before with the light-based examples. All fluid amounts between empty and full can be determined by sensing along the direction orthogonal to the fluid surface. Similar results may be achieved for a non-orthogonal incident direction for the emitted ultrasound, since the lower directionality of ultrasound compared to light beams can still return some reflected energy from the fluid surface to the transducer for detection. The fluid sensing can be carried out on a continuous basis during refilling so that the controller is always aware of the current fluid amount and can cease the refilling when a required amount of fluid is reached. Alternatively, the controller may acquire information on a periodic basis only, or in order to determine that refilling is required (the storage area is at least partially empty) and then, after an appropriate time period based on the required volume of fluid to fill the storage area and the rate of fluid delivery, make one or more further determinations to ensure that the storage area is properly filled.

FIG. 12 shows a highly simplified schematic view of a second example of an ultrasound-based fluid sensing system. In this example, the article 30 is arranged with the orifice 60 at a high level in a side wall 3a of the storage area 3. The ultrasound transducer 75 is arranged to direct emitted ultrasound Ee through the orifice 60 along a propagation direction which is non-orthogonal to the surface 70a of fluid in the storage area 3, in specifically in this example, substantially parallel to the fluid surface 70a. When the fluid surface 70a is below the height of the orifice 60, the emitted ultrasound Ee will propagate through the air in the empty upper part of the interior of the storage area 3 until it reaches the opposite wall 3b of the storage area. A portion of the energy of the emitted ultrasound Ee will be reflected from the opposite wall 3b back towards the orifice, to form returned ultrasound waves Er for detection by the transducer 75. A first level of ultrasound energy or power will be detected, based on the level of reflectivity at the air interface with the opposite wall 3b and attenuation of the ultrasound as it propagates in air.

When the fluid surface 70a′ is above the height of the orifice 60, the emitted ultrasound Ee and the returned ultrasound Er reflected from the opposite wall will propagate through the fluid 70, rather than through air. Hence, a second level of ultrasound energy or power, different from the first, will be detected, based on the level of reflectivity at the fluid interface with the opposite wall 3b and attenuation of the ultrasound at it propagates in the fluid.

Hence, the value of the output from the ultrasound transducer corresponding to the returned ultrasound waves Er will be different depending on whether the surface 70a of the fluid 70 in the storage area 3 is below or above the orifice 60. Hence, the controller is able to distinguish between the storage area 3 being “not full” (fluid surface 70a below the orifice 60) and “full” (fluid surface 70a above the orifice 60), in a similar manner to that described for the light-based example of FIGS. 10A and 10B. As in that example, the controller can monitor the amount of fluid continuously during a filling action, or periodically, as preferred. Output signals corresponding to “full” and “not full” can be distinguished by comparison with stored signatures or values for one or both of these states, or by looking for a change in the output signal that occurs as the fluid level rises past the orifice during filling, again as described for FIGS. 10A and 10B.

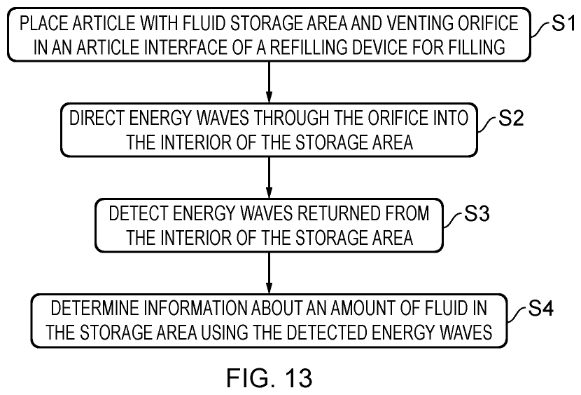

FIG. 13 shows a flow chart of steps in an example method for determining fluid amount in a fillable article. In a first step S1, an article of an aerosol provision system having a storage area for fluid and an orifice to vent air from the interior of the storage area to the exterior of the article is placed or received or otherwise held in an article interface of a refilling device for filling an article from a reservoir. In a second step S2, energy waves are emitted and directed through the orifice and into the interior of the storage area. In a third step S3, energy waves returned from the interior of the storage area are detected. In a fourth step S4, information about an amount of fluid in the storage area is determined using the detected energy waves (such as in the form of an output from a detector used to detect the returned energy waves). The obtained information about the amount of fluid in the storage area can be used to control filling of the article from the reservoir by the refilling device, such as by the generation of control signals for a filling arrangement or fluid transfer mechanism by a controller of the refilling device in response to the information about the amount of fluid in the storage area.

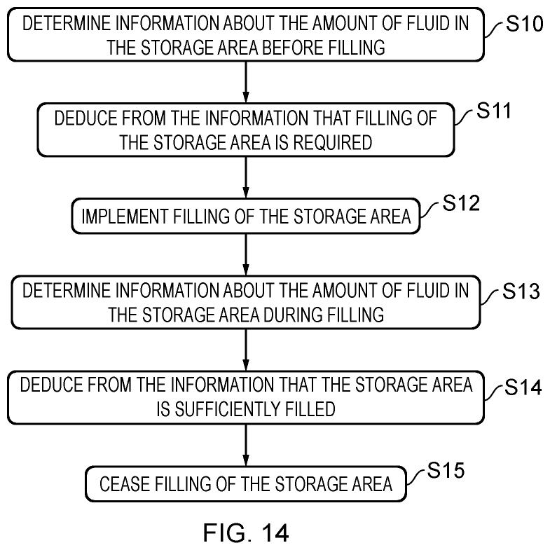

FIG. 14 shows a flow chart of steps in an example method for refilling an article using information determined using a method such as the FIG. 13 example. In a first step S10, information about the amount of fluid in the storage area of an article is determined, such as according to FIG. 13, before a filling action is implemented by the refilling device. In a next step S11, the information is used to deduce that filling of the storage area is required, i.e. that the amount of fluid in the storage area is less than a desired amount. If it is decided that filling is required, the method proceeds to step S12, in which filling of the storage area is implemented. If desired, the method can continue with step S13, where information about the amount of fluid in the storage area is determined one or more times or continuously during the filling. In step S14, at some point it is deduced from the information determined in step S13 that the storage area is sufficiently filled. The method then ends in step S15 by the filling of the storage area being ceased.

Note that the steps S12-S15 may be implemented as a self-contained method, without prior determination that filling is required according to steps S10 and S11. This may be done if, for example, the refilling dock includes some other system for determining that an article is empty when it is placed into the article interface (weighing the article, for example), or if it is simply assumed that any article received in the interface must require at least a partial refill, so that a filling action can be implemented directly.

The various embodiments described herein are presented only to assist in understanding and teaching the claimed features. These embodiments are provided as a representative sample of embodiments only, and are not exhaustive and/or exclusive. It is to be understood that advantages, embodiments, examples, functions, features, structures, and/or other aspects described herein are not to be considered limitations on the scope of the invention as defined by the claims or limitations on equivalents to the claims, and that other embodiments may be utilised and modifications may be made without departing from the scope of the claimed invention. Various embodiments of the invention may suitably comprise, consist of, or consist essentially of, appropriate combinations of the disclosed elements, components, features, parts, steps, means, etc., other than those specifically described herein. In addition, this disclosure may include other inventions not presently claimed, but which may be claimed in future.

1. A refilling device for filling an article from a reservoir, comprising:
an article interface for receiving an article of an aerosol provision system, the article having a storage area for fluid and an orifice to vent air from the interior of the storage area to the exterior of the article;
an energy source operable to emit energy waves, and configured to direct energy waves through the orifice and into the interior of the storage area of an article received in the article interface;
a detector operable to detect energy waves returned through the orifice from the interior of the storage area and generate a corresponding output; and
a controller configured to determine information about an amount of fluid in the storage area using the output of the detector.

2. A refilling device according to claim 1, wherein the orifice comprises a valve or cover that closes the orifice when the article is in use, and the refilling device comprises a orifice opening mechanism configured to open the orifice when the article is received in the article interface.

3. A refilling device according to claim 1, wherein the refilling device comprises a nozzle configured to engage with the orifice when the article is received in the article interface, the nozzle defining a channel along which the energy waves are directed and returned.

4. A refilling device according to claim 1, wherein the energy source comprises an optical source operable to emit energy waves in the form of light, and the detector comprises an optical detector configured to detect the light.

5. A refilling device according to claim 4, wherein the optical source and the optical detector are arranged such that light emitted from the optical source is directly reflected from a surface of fluid in the storage area for return to the optical detector.

6. A refilling device according to claim 5, wherein the light is directed and returned substantially vertically.

7. A refilling device according to claim 5, wherein the controller is configured to determine information about the amount of fluid by calculating a time of flight for light returned along the venting path after reflection from the surface of the fluid and deducing a position of the surface of the fluid within the storage area from the time of flight.

8. A refilling device according to claim 4, wherein the optical source and the optical detector are arranged such that light emitted from the optical source is returned to the optical detector other than by direct reflection from a surface of fluid in the storage area.

9. A refilling device according to claim 8, wherein the optical source is arranged such that emitted light is directed substantially parallel to a surface of fluid in the storage area.

10. A refilling device according to claim 9, wherein the optical detector is positioned to detect light reflected from an interior surface of the article while the surface of the fluid is below the orifice.

11. A refilling device according to claim 8, wherein the controller is configured to determine information about the amount of fluid in the storage area by identifying the presence or absence of a characteristic of the returned light which is caused by the surface of the fluid in the storage area being at or above the orifice.

12. A refilling device according to claim 8, wherein the controller is configured to determine information about the amount of fluid in the storage area by identifying a change in the returned light caused by the surface of the fluid in the storage area reaching the orifice.

13. A refilling device according to claim 4, wherein the optical source is configured to emit light and the controller is configured to determine information about the amount of fluid two or more times during filling of the storage area.

14. A refilling device according to claim 4, wherein the optical source is configured to emit pulses of light during filling of the storage area and the controller is configured to determine information about the amount of fluid in the storage area using the output of the detector for one or more pulses of light.

15. A refilling device according to claim 14, wherein the controller is configured to determine information about the amount of fluid in the storage area using the output of the detector for every nth pulse of light or the controller is configured to determine information about the amount of fluid in the storage area using the output of the detector for substantially every pulse of light.

16. (canceled)

17. A refilling device according to claim 4, wherein the optical source is configured to emit light continuously during filling of the storage area.

18. A refilling device according to claim 17, wherein the controller is configured to determine information about the amount of fluid in the storage area using the output of the detector continuously during filling of the storage area or the controller is configured to determine information about the amount of fluid in the storage area using the output of the detector periodically during filling of the storage area.

19. (canceled)

20. (canceled)

21. (canceled)

22. (canceled)

23. A refilling device according to claim 1, wherein the controller is configured to determine information about the amount of fluid in the storage area before a filling of the storage area, deduce from the information that filling of the storage area is required, and in response, control the refilling device to cause filling of the storage area.

24. A refilling device according to claim 1, wherein the controller is configured to determine information about an amount of fluid in the storage area during filling of the storage area, deduce from the information that the storage area is sufficiently filled, and in response, control the refilling device to cease filling of the storage area.

25. A method of sensing fluid in a storage area of an article, the method comprising:
holding an article of an aerosol provision system in an article interface of a refilling device, the article having a storage area for fluid and an orifice to vent air from the interior of the storage area to the exterior of the article;
directing energy waves through the orifice and into the interior of the storage area;
detecting energy waves returned from the interior of the storage area; and
determining information about an amount of fluid in the storage area using the detected energy waves.
